(19) United States
(12) Patent Application Publication
(10) Pub. No.: US 2024/0046361 A1
(43) Pub. Date: Feb. 8, 2024

(54) SYSTEMS AND METHODS FOR VEHICLE DAMAGE IDENTIFICATION AND INSURANCE CLAIM PROCESSING

(71) Applicant: Allstate Insurance Company, Northbrook, IL (US)

(72) Inventors: Clint J. Marlow, Barrington Hills, IL (US); Kartik Raosharada, Northbrook, IL (US); Joseph Skillman, Northbrook, IL (US)

(73) Assignee: Allstate Insurance Company, Northbrook, IL (US)

(21) Appl. No.: 17/879,489

(22) Filed: Aug. 2, 2022

(51) Int. Cl. G06Q 40/08; G06V 10/44

(52) U.S. Cl. CPC G06Q 40/08; G06V 10/443

(57) ABSTRACT

A method for processing insurance claims including receiving, by a provider computing system, background data, generating, by the provider computing system, a damage prediction model based on the background data, receiving, from a customer device, a first insurance claim corresponding to a first storm, generating, by the provider computing system, a first storm damage prediction for the first storm, applying, by the provider computing system, the first storm damage prediction to the first insurance claim, receiving, from the customer device, a first corrected insurance claim based on storm damage data, and generating, by the provider computing system, a first updated damage prediction model based on the background data and the first corrected insurance claim.

### TECHNICAL FIELD

The present disclosure relates to systems and method for vehicle damage identification and insurance claim processing.

### BACKGROUND

Weather events, such as hail storms, may damage body panels of an insured vehicle belonging to a customer of an insurance provider. Present methods for submitting claims include the customer contacting the insurance provider, scheduling an appointment, and driving to a claims center. Contacting the insurance provider, claims center hours, claims center location, and wait times may all frustrate a customer that is already dealing with stress associated with vehicle damage.

### SUMMARY

In one embodiment, a method for processing insurance claims comprises receiving, by a provider computing system, background data; generating, by the provider computing system, a damage prediction model based on the background data; receiving, from a first customer device, a first insurance claim for a vehicle, the first insurance claim corresponding to a first storm; generating, by the provider computing system, a first storm damage prediction of damage to the vehicle due to the first storm; applying, by the provider computing system, the first storm damage prediction to the first insurance claim; receiving, from the customer device, a first storm damage information based on actual damage to the vehicle from the first storm; receiving, by the provider computing system, first storm weather data; and generating, by the provider computing system, a first updated damage prediction model based on the background data, the new storm weather data, and the first storm damage information.

Another embodiment relates to an insurance claim processing system. The insurance claim processing system comprises a first customer device and a provider computing system communicatively coupled to the first customer device, the provider computing system comprising a processor and a memory. The memory stores instructions that cause the processor to: receive background data; generate a damage prediction model based on the background data; receive, from the first customer device, a first insurance claim for a vehicle, the first insurance corresponding to a first storm; generate a first storm damage prediction of damage to the vehicle due to the first storm; apply the first storm damage prediction to the first insurance claim; receive, from the customer device, a first storm damage information based actual damage to the vehicle from the first storm; and generate a first updated damage prediction model based on the background data, the new storm weather data, and the first storm damage information.

Another embodiment relates to a non-transitory computer readable medium having computer-executable instructions embodied therein that, when executed by a processor of a computing system, cause the computing system to perform operations to process insurance claims. The operations include: receive background data; generate a damage prediction model based on the background data; receive, from the first customer device, a first insurance claim for a vehicle, the first insurance corresponding to a first storm; generate a first storm damage prediction of damage to the vehicle due to the first storm; apply the first storm damage prediction to the first insurance claim; receive, from the customer device, a first storm damage information based actual damage to the vehicle from the first storm; and generate a first updated damage prediction model based on the background data, the new storm weather data, and the first storm damage information.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a component diagram of an claim processing system, according to an exemplary embodiment;

FIG. 2 is a flow diagram of a method of generating and updating a damage prediction model, according to an exemplary embodiment;

FIG. 3 is a flow diagram of a method of processing a claim and issuing a claim result, according to an exemplary embodiment;

FIG. 4 is an illustration of a customer device displaying a user interface prompting a customer to prepare for submitting a claim, according to an exemplary embodiment;

FIG. 5 is an illustration of a customer device displaying a user interface prompting a customer to select panels of a vehicle, according to an exemplary embodiment;

FIGS. 6A-D are illustrations of a customer device displaying a user interface prompting a customer to select damage intensity, according to an exemplary embodiment;

FIG. 7 is an illustration of a customer device displaying a user interface prompting a customer to select damage size, according to an exemplary embodiment;

FIG. 8 is an illustration of a customer device displaying a user interface prompting a customer watch an informational video and upload damage photos, according to an exemplary embodiment;

FIG. 9 is an illustration of a customer device displaying a user interface displaying an upload confirmation, according to an exemplary embodiment; and

FIG. 10 is an illustration of a customer device displaying a user interface prompting a customer to confirm pre-populated additional information, according to an exemplary embodiment.

FIG. 11 is an illustration of a customer device displaying a user interface displaying a summary of an insurance claim, according to an exemplary embodiment.

### DETAILED DESCRIPTION

Referring generally to the figures, systems and methods for vehicle damage identification and insurance claim processing are disclosed. A vehicle may be any type of passenger or non-passenger device for transporting goods or people, which may be via one or more of land, air, or water, such as but not limited to sedans, trucks, minivans, motorcycles, recreational vehicles, boats, tractor-trailers, drones, and airplanes. The systems and methods described herein enhance insurance claim processing by utilizing a claim processing system to gather storm data, generate a storm damage prediction, and provide a customer with pre-populated information to expedite the insurance claim process. The embodiments of the claim processing system described herein cannot be done by conventional claim processing systems and/or human actors. For example, the claim processing system generates damage predictions for future weather events based on past storm data and damage data.

In some embodiments, the claim processing system receives an insurance claim (also referred to as a “claim”) from a customer corresponding to damage (e.g., dents, scratches, etc.) resulting from a weather event (also referred to as a “storm”), such as a hail storm. The claim processing system confirms whether a damage-inducing storm occurred on the date indicated in the insurance claim. The claim processing system may also confirm whether the vehicle is eligible for a claim. Once the date is confirmed, the claim processing system provides the customer, via a customer device, a series of screens, each prompting the user to enter information. The information may be pre-populated based on the claim processing system generating a damage prediction. The damage prediction is generated by the claim processing system using computer processes and/or algorithms, such as artificial intelligence (e.g., machine learning) algorithms, that utilize data corresponding to past storm data, current storm data, damage data, claim data, and the like. The pre-populated information allows for the customer to quickly generate their claim. The customer may correct the pre-populated information if the pre-populated information does not correspond to actual status of the vehicle. The corrected information is utilized by the claim processing system to improve future storm damage predictions and increasing the likelihood that the pre-populated information corresponds to the actual status (e.g., state of damage, etc.) of the vehicle. Once the customer has corrected and/or verified the information, the customer uploads images of the vehicle damage to the claim processing system. The images may be analyzed (e.g., via a computer vision algorithm, etc.) to determine if the vehicle damage depicted in the images corresponds to the status of the vehicle described in the claim. Once the claim is completed, the claim processing system routes the claim to an adjuster device, which allows for an adjuster to review the claim and issue a claim result. The claim processing system may recommend repair facilities, where the customer may get the claimed damage repaired. If, during claim processing, the claim processing system determines an irregularity (e.g., damage severity is greater than expected, prior damage, etc.), the claim processing system may reroute the claim to another claim processing pathway.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting. Specifically, the embodiments described herein generally relate to claims relating to damage resulting from a hail storm. The systems and methods described herein may be applied to other damage-inducing situations (e.g., wind storm, lightning strike, rain, snow, etc.).

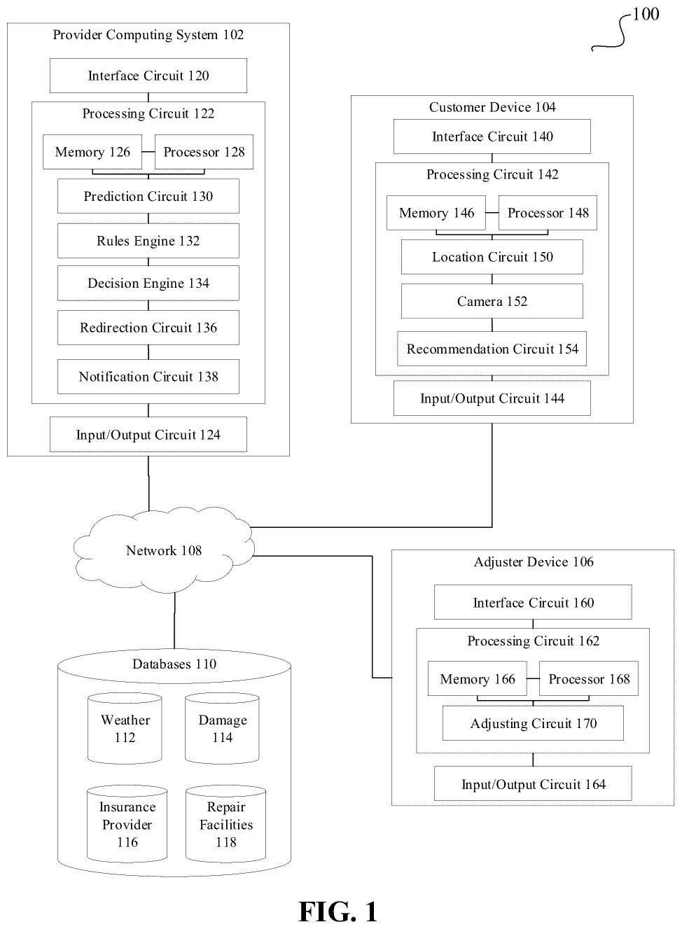

FIG. 1 is a component diagram of a claim processing system 100, according to an exemplary embodiment. The claim processing system 100 processes damage claims submitted by a customer to an insurance provider. The claim processing system 100 also generates damage prediction models to expedite and verify the claims based on past and current data relating to storms and claims. The claims processing system 100 includes a provider computing system 102, a customer device 104, an adjuster device 106, all communicatively coupled (e.g., wirelessly, via-a-wire, etc.) via a network 108. Databases 110 are further communicatively coupled to the network 108. In some embodiments, the provider computing system 102, the customer device 104, and/or the adjuster device 106 may be directly communicatively coupled to the databases 110. The provider computing system 102, the customer device 104, and the adjuster device 106 are configured to receive and process an insurance claim by utilizing the databases 110, which include a weather database 112, a damage database 114, an insurance provider database 116 and a repair facilities database 118. In some embodiments, the insurance claim corresponds to a claim of damage to a vehicle resulting from a storm, such as panel damage from a hail storm.

The provider computing system 102 is configured to complete back-end (e.g., non-customer facing) operations during claim processing. In one embodiment, the provider computing system 102 includes an interface circuit 120, a processing circuit 122, and an input/output circuit 124.

The interface circuit 120 may include components, subsystems, data structures, modules, scripts, applications, or one or more sets of processor-executable instructions for establishing connections within the claim processing system 100 by way of the network 108. The interface circuit 120 may further facilitate intercommunication of the components of the provider computing system 102. The interface circuit 120 includes programming and/or hardware-based components that connect the provider computing system 102 to the network 108. For example, the interface circuit 120 may include a combination of a wireless network transceiver (e.g., a cellular modem, a Bluetooth transceiver, a Wi-Fi transceiver) and/or a wired network transceiver (e.g., an Ethernet transceiver). In some embodiments, the interface circuit 120 includes the hardware and machine-readable media structured to support communication over multiple channels of data communication (e.g., wireless, Bluetooth, near-field communication, etc.). In some embodiments, the interface circuit 120 includes cryptography module(s) to establish a secure communication session (e.g., using IPSec protocol or similar) in which data communicated over the session is encrypted and securely transmitted. To support the features of the provider computing system 102, the interface circuit provides a connection, such as a relatively high-speed link, to the network 108, which may be any combination of a local area network (LAN), an intranet (e.g., a private banking or retailer network), the Internet, or any other suitable communications network, directly or through another interface.

The processing circuit 122 may include components, subsystems, data structures, modules, scripts, applications, or one or more sets of processor-executable instructions for facilitating claim processing. The processing circuit 122 comprises a memory 126, a processor 128, a prediction circuit 130, a rules engine 132, a decision engine 134, a redirection circuit 136, and a notification circuit 138. The memory 126 includes one or more memory device (e.g., RAM, NVRAM, ROM, Flash Memory, hard disk storage) that store data and/or computer code for facilitating the various processes described herein. That is, in operation and use, the memory 126 stores at least portions of instructions and data for execution by the processor 128 to control the processing circuit 122. The memory 126 may be or include tangible, non-transient volatile memory and/or non-volatile memory. The processor 128 may be implemented as a general-purpose processor, an application specific integrated circuit (ASIC), one or more field programmable gate arrays (FPGAs), a digital signal processor (DSP), a group of processing components, or other suitable electronic processing components.

The prediction circuit 130 may include components, subsystems, data structures, modules, scripts, applications, or one or more sets of processor-executable instructions for generating a damage prediction model by utilizing data received from at least one database of the databases 110 and/or from other sources (e.g., from the customer, etc.). For example, the prediction circuit 130 may utilize data from the weather database 112 and the damage database 114. The weather database 112 may include historical data corresponding to characteristics (e.g., temperature, wind speed, cloud size, hail size, precipitation measurements, duration, location, etc.) of weather events (e.g., storms, etc.). The damage database 114 may include historical information (e.g., number, depth, width, location, etc.) relating to damage (e.g., dents, scrapes, broken glass, etc.) resulting from a weather event. The data in the weather database 112 and the damage database 114 may be linked such that a set of damage data all resulting from a common weather event may be linked to a set of characteristics corresponding to the common weather event. The data in the databases 110 may be populated based on previous insurance claims and may further include the result of the claims (e.g., type of repair completed, whether a check was issued, etc.). The prediction circuit 130 generates a damage prediction model by utilizing an artificial intelligence (e.g., machine learning, etc.) algorithm that uses the data from the databases 110 as input variables. The artificial intelligence algorithm may utilize machine classifiers that are used to calculate and classify data to generate the damage prediction model. The machine classifiers calculate one or more feature vector based on location-specific historical weather data (e.g., hail associated wind, hail density, storm duration, wind shear, kinetic energy, etc.) in combination with location specific historical hail damage estimate data (e.g., damaged panels, hail dent count, hail dent size, repair or replace decisions, etc.). In some embodiments, artificial intelligence algorithms utilizing machine classifiers may normalize to incoming recent storm data. For example, for the first 100 or so claims that are location-specific to a recent storm, the artificial intelligence algorithm uses historical feature vectors to inform machine classifiers. Once additional data and claims related to the recent storm are received, the machine classifiers would transition to use recent storm, or storm data from the same storm season, weather and estimate data.

The damage prediction model can be applied to new weather events to predict damage that may results from the new wind storm. In some embodiments, the prediction circuit 130 receives additional data (e.g., submitted claims, damage reports, etc.) corresponding to the new weather event to refine the damage prediction model both generally (e.g., for all future weather events) and specifically (e.g., for the new weather event). In some embodiments, data relating to the same weather event as currently modeled may have a larger weight (e.g., larger effect on the result of the damage prediction model) than data from other weather events. The damage prediction model may be utilized to pre-populate at least a portion of an insurance claim corresponding to damage from a storm.

The rules engine 132 is a circuit that may include components, subsystems, data structures, modules, scripts, applications, or one or more sets of processor-executable instructions for validating portions of the claim during the claim process. In some embodiments, the rules engine 132 may be a sub-circuit of the prediction circuit 130. The rules engine 132 compares certain portions of the claim entered by the customer against data from the databases 110 and against the damage prediction model. For example, the rules engine 132 may determine if the date and location indicated on the insurance claim corresponds to a known weather event, such as a weather event stored in the weather database 112. Furthermore, the rules engine 132 may further determine if the weather event corresponding to the date and location of the insurance claim is damage-inducing. For example, the rules engine 132 may determine that a weather event including only a light drizzle is not damage-inducing, while a weather event including a hail-storm may be damage-inducing. In some embodiments, the rules engine 132 may include a damage threshold, corresponding to a minimal hail size, wherein hail at or larger than the minimum hail size is damage-inducing. If the rules engine 132 determines that the claimed damage did not occur at a time and location that experienced a weather event, or did not experience a damage-inducing weather event, the rules engine 132 may flag the claim.

The rules engine 132 may further determine whether the object (e.g., vehicle, etc.) of the insurance claim has an prior un-repaired damage by comparing the object of the insurance claim to data from the insurance provider database 116, which may include previous claim information including damages, repair information, and the like. For example, the rules engine 132 may determine that the roof panel of a car was damaged previously and the damage was never repaired, as indicated by a lack of body shop or vendor payment or reimbursement. If the rules engine 132 determines that the object of the insurance claim has prior un-repaired damage, the rules engine 132 may flag the claim.

The rules engine 132 may further determine whether information entered by the customer in the claim corresponds to what is expected for the weather event. For example, the rules engine 132 may compare the characteristics (e.g., depth, width, number, etc.) of the damage indicated by the customer to the damage prediction model to determine whether the damage corresponds to what is expected for the weather event. In some embodiments, the rules engine 132 may factor in the object type (e.g., panel material, paint type, etc.) when determining whether the information entered by the customer corresponds to what is expected for the weather event. For example, the rules engine 132 may consider the vehicle, such as that steel panels are more resilient to damage than aluminum panels, in comparing the characteristics of the damage. If the rules engine 132 determines that the information entered by the customer in the claim does not corresponds to what is expected, the rules engine 132 may flag the claim. Claims flagged by the rules engine 132 may be redirected by the redirection circuit 136. For example, flagged claims may exit the current claim processing pathway and be redirected to a manual claim processing pathway (e.g., customer calls insurance provider to process claim, customer processes claim at insurance provider facility, etc.).

The decision engine 134 is a circuit that may include components, subsystems, data structures, modules, scripts, applications, or one or more sets of processor-executable instructions for determining whether photos (e.g., images, etc.) of the damage submitted by the customer correspond to damage indicated by the customer in the claim. The decision engine 134 may apply image detections algorithms, such as artificial intelligence (e.g., computer vision, etc.) algorithms to the photos of the damage to extract characteristics of the damaged portions of the claimed damaged object. For example, the decision engine 134 may extract the number, size and location of dents on the claimed damaged object from the images of the damage. In some embodiments, the artificial intelligence algorithms may be utilized to determine a confidence threshold based on the photos of damage, the confidence threshold corresponding to how similar the artificial intelligence algorithm determines the photos of damage to be to the claim. The decision engine 134 may further use artificial intelligence algorithms to determine if multiple images depict the same damage, reducing or eliminating the likelihood of the decision engine 134 double-counting damaged portions. To maximize efficiency, the decision engine 134 may only extract the characteristics from the photos that correspond to the characteristics noted in the insurance claim. Once the decision engine 134 extracts the characteristics from the photos of the damage, the decision engine 134 compares the characteristics extracted from the photos to the information indicated in the claim. Based on the comparison, the decision engine 134 decides if the information indicated in the claim matches the characteristics extracted from the photos. This determination allows for the claim processing system 100 to determine claims that may not follow the damage prediction model. For example, if a vehicle is parked underneath a tree during a hail storm, the vehicle may be partially shielded from the expected damage. In some embodiments, if the decision engine 134 determines that the information indicated in the claim does not match the characteristic extracted from the photos, the decision engine 134 may prompt a user, which may be a user on the insurance provider-side or on the customer-side, to enter any supplemental information about the claim, which may indicate why the information indicated in the claim does not match the characteristics extracted from the photos. The supplemental information may be used to correct the information in the claim and/or may be utilized by an artificial intelligence algorithm to further revise the damage prediction model.

If the decision engine 134 determines that the information indicated in the claim matches the characteristic extracted from the photos, the decision engine 134 may prefill a claim estimate. The claim estimate includes at least an estimate for the cost to repair the damage and may include as well, any other cost that may need to be covered by the insurance provider. The decision engine 134 may prefill the claim estimate based on past claim information that is stored in the insurance provider database 116. For example, the decision engine 134 may determine a first severity of damage (e.g., number of damaged portions, size of damaged portions, etc.) corresponds to a first cost while a second severity of damage corresponds to a second cost, and so on, thus creating a cost/severity table. The decision engine 134 then compares the claimed severity of damage to the cost/severity table to determine a cost for the claim.

The redirection circuit 136 may include components, subsystems, data structures, modules, scripts, applications, or one or more sets of processor-executable instructions for redirecting the claim, and the information corresponding to the claim, to different circuits and devices of the claim processing system 100 and, in some embodiments, to devices outside of the claim processing system 100. The redirection circuit 136 may redirect insurance claims flagged by the rules engine 132 to the adjuster device 106 or to an employee device associated with the insurance provider. The flagged claims may require manual input form an employee of the insurance provider. In some embodiments, the redirection circuit 136 may direct the customer submitting the claim to contact the insurance provider (e.g., via e-mail, via telephone call, via text messaging service, via video call, etc.) to continue the claim process outside of the scope of the claim processing system 100. In some embodiments, the redirection circuit 136 may direct claims outside of the claim processing system 100 to the claim processing system. For example, if a claim is flagged and the submitting customer is directed, by the redirection circuit 136, to contact an employee of the insurance provider, the employee and the customer may correct (e.g., revise, supplement, adjust, etc.) the issue that resulted in the claim being flagged. Once corrected claim, and the customer, may then be directed back to the claim processing system 100.

The redirection circuit 136 may redirect the claim to the adjuster device 106, so that an insurance adjuster, or other employee of the insurance provider, may review photos, data, and the estimate of the claim for accuracy and make any needed corrections. Once the adjuster has confirmed the claim, the redirection circuit 136 may also be configured to upload and issue results and information associated with the claim process, after the claim process is completed. The redirection circuit 136 may upload, via the network 108, at least a portion of the information associated with claim to at least one of the databases 110. For example, the redirection circuit 136 may upload the images of the claimed damage to the damage database 114 and the information corresponding to the claim into the insurance provider database 116. In some embodiments, the information and images may be linked together. In some embodiments, the images and information and images uploaded to the databases 110 may be anonymized (e.g., all identifying information is removed). In some embodiments, the redirection circuit 136 may continuously upload information associated with the claim to at least one of the databases 110 to save the claim process, and which may be accessed at a later time. This may allow for a customer to return to complete a claim incrementally, increasing convenience for the customer.

The notification circuit 138 may include components, subsystems, data structures, modules, scripts, applications, or one or more sets of processor-executable instructions for sending a notification to the customer, the insurance provider, and/or other entities about the status of the claim. The notification may include an indication that the insurance claim has been rejected, an indication that supplemental information is required, or an indication that the claim has been accepted. The notification circuit 138 maybe configured to send notifications directly, by sending signals, e-mails, digital notification, indicator light, smartphone push notifications, and the like, and/or may send signals to other notification device or services, such as a post mailing system or the like, which then may send a notification to a recipient.

The input/output circuit 124 is structured to receive communication from and provide communications to provider computing system 102. The input/output circuit 124 may be structured to communication, exchange data, communication, instructions, etc. with input/output components (e.g., circuitry) of other systems, devices, etc. In some embodiments, the input/output circuit 124 includes an input/output device, such as a touchscreen. In another embodiment, the input/output circuit 124 includes machine-readable media for facilitating the exchange of information between an input/output device and the components of the provider computing system 102. In some embodiments, the input/output circuit 124 includes any combination of hardware components, communication circuitry, and machine-readable media. Hardware components can include a touchscreen, a keypad, microphone, camera, or buttons for receiving user inputs. Components of the input/output circuit 124 display instructions, status notification and other information (e.g., claim processing progress) to a user. The display (e.g., the touchscreen) may be configured to display graphics such as menus, instructions, background photos (e.g., advertisements, etc.), logos, and so on. In one embodiment, the display is a touchscreen display that is capable of detecting user touches, e.g., to make menu selections. The display allows for an insurance provider to monitor and/or adjust the claim, claim process, and/or the damage prediction model.

The customer device 104 is a device (e.g., mobile device, laptop computer, desktop computer, tablet, smart device, public computer, etc.) that a customer of the insurance provider may use to access insurance provider resources (e.g., applications, databases, account information, websites, etc.). The customer device 104 may be used by a customer to proceed through processing a claim. For example, the customer device 104 may be a customer's mobile device which includes a financial institution application. The customer may then access the financial institution application and attempt to process an insurance claim. The customer device 104 includes an interface circuit 140, a processing circuit 142, and an input/output circuit 144.

The interface circuit 140 may include components, subsystems, data structures, modules, scripts, applications, or one or more sets of processor-executable instructions for establishing connections within the claim processing system 100 by way of the network 108. The interface circuit 140 may further facilitate intercommunication of the components of the customer device 104. The interface circuit 140 includes programming and/or hardware-based components that connect the customer device 104 to the network 108. For example, the interface circuit 140 may include a combination of a wireless network transceiver (e.g., a cellular modem, a Bluetooth transceiver, a Wi-Fi transceiver) and/or a wired network transceiver (e.g., an Ethernet transceiver). In some embodiments, the interface circuit 140 includes the hardware and machine-readable media structured to support communication over multiple channels of data communication (e.g., wireless, Bluetooth, near-field communication, etc.). In some embodiments, the interface circuit 140 includes cryptography module(s) to establish a secure communication session (e.g., using IPSec protocol or similar) in which data communicated over the session is encrypted and securely transmitted. To support the features of the customer device 104, the interface circuit provides a connection, such as a relatively high-speed link, to the network 108, which may be any combination of a local area network (LAN), an intranet (e.g., a private banking or retailer network), the Internet, or any other suitable communications network, directly or through another interface.

The processing circuit 142 may include components, subsystems, data structures, modules, scripts, applications, or one or more sets of processor-executable instructions for facilitating claim processing. The processing circuit 142 comprises a memory 146, a processor 148, a location circuit 150, a camera 152, and a recommendation circuit 154. The memory 146 includes one or more memory device (e.g., RAM, NVRAM, ROM, Flash Memory, hard disk storage) that store data and/or computer code for facilitating the various processes described herein. That is, in operation and use, the memory 146 stores at least portions of instructions and data for execution by the processor 148 to control the processing circuit 142. The memory 146 may be or include tangible, non-transient volatile memory and/or non-volatile memory. The processor 148 may be implemented as a general-purpose processor, an application specific integrated circuit (ASIC), one or more field programmable gate arrays (FPGAs), a digital signal processor (DSP), a group of processing components, or other suitable electronic processing components.

The location circuit 150 may include components, subsystems, data structures, modules, scripts, applications, or one or more sets of processor-executable instructions for determining the location of the customer device 104. The location circuit 150 may utilize position systems such as GPS, GLONASS, or the like, to determine the position of the customer device 104. In some embodiments, the location circuit 150 may provide the customer with a map and may prompt the customer to enter the customer's location and/or the location of the claimed damage. In some embodiments, the location circuit 150 may be included in a vehicle and may communicate with the customer device 104 via the network 108.

The camera 152 is configured to capture images of the claimed damage. In some embodiments, the camera 152 may include artificial intelligence algorithms that assist the customer in capturing photos of the claimed damage. For example, the algorithms may inform the user when the framing of the image is desired (e.g., entire panel is in view) and/or when the lighting condition are desired (e.g., the claimed damage can be seen clearly). Once a photo is captured, the image may be saved to the memory 146 of the customer device, or may be uploaded to the damage database 114 via the network 108. The captured photos may then be utilized in the claim process as described in reference to the decision engine 134 of the provider computing system 102.

The recommendation circuit 154 may include components, subsystems, data structures, modules, scripts, applications, or one or more sets of processor-executable instructions for providing a customer with a repair recommendation. Once the provider computing system 102 approves an insurance claim, the customer may indicate whether the customer is interested in receiving a repair facility recommendation from the insurance provider. The repair facilities recommended by the insurance provider may be a repair facility partnered with the insurance provider. The recommendation circuit 154 determines which repair facilities from a repair facilities database 118, are recommended for the customer. The recommendation circuit 154 may utilize the location data from the location circuit 150 to determine which repair facilities are nearest to the customer. In some embodiments, the recommendation circuit 154 may be configured to access repair facility schedules to determine open hours and openings for repair. In some embodiments, the recommendation circuit 154 may automatically schedule an apportionment for repair upon receiving confirmation from the customer. In some embodiments, the customer may indicate a preference (e.g., closest facility, preferred hours, etc.) that the recommendation circuit 154 further uses to refine the repair facility recommendations.

The input/output circuit 144 is structured to receive communication from and provide communications to the customer device 104. The input/output circuit 144 may be structured to communicate, exchange data, instructions, etc. with input/output components (e.g., circuitry) of other systems, devices, etc. In some embodiments, the input/output circuit 144 includes an input/output device, such as a touchscreen. In another embodiment, the input/output circuit 144 includes machine-readable media for facilitating the exchange of information between an input/output device and the components of the customer device 104. In some embodiments, the input/output circuit 144 includes any combination of hardware components, communication circuitry, and machine-readable media. Hardware components can include a touchscreen, a keypad, microphone, camera, or buttons for receiving user inputs. Components of the input/output circuit 144 display instructions, status notification and other information (e.g., claim processing progress) to a user. The display (e.g., the touchscreen) may be configured to display graphics such as menus, instructions, background photos (e.g., advertisements, etc.), logos, and so on. In one embodiment, the display is a touchscreen display that is capable of detecting user touches, e.g., to make menu selections. The display allows for the customer device 104 to communicate with a customer and display instructions for claim processing.

The adjuster device 106 is a device (e.g., mobile device, laptop computer, desktop computer, tablet, smart device, public computer, etc.) that is associated with an adjuster (e.g., employee, contracted employee, etc.) of the insurance provider. The adjuster, via the adjuster device 106, review the claims for completeness, accuracy, and make corrections and adjustments to the claim based on the review.

The interface circuit 160 may include components, subsystems, data structures, modules, scripts, applications, or one or more sets of processor-executable instructions for establishing connections within the claim processing system 100 by way of the network 108. The interface circuit 160 may further facilitate intercommunication of the components of the adjuster device 106. The interface circuit 160 includes programming and/or hardware-based components that connect the adjuster device 106 to the network 108. For example, the interface circuit 160 may include a combination of a wireless network transceiver (e.g., a cellular modem, a Bluetooth transceiver, a Wi-Fi transceiver) and/or a wired network transceiver (e.g., an Ethernet transceiver). In some embodiments, the interface circuit 160 includes the hardware and machine-readable media structured to support communication over multiple channels of data communication (e.g., wireless, Bluetooth, near-field communication, etc.). In some embodiments, the interface circuit 160 includes cryptography module(s) to establish a secure communication session (e.g., using IPSec protocol or similar) in which data communicated over the session is encrypted and securely transmitted. To support the features of the adjuster device 106, the interface circuit provides a connection, such as a relatively high-speed link, to the network 108, which may be any combination of a local area network (LAN), an intranet (e.g., a private banking or retailer network), the Internet, or any other suitable communications network, directly or through another interface.

The processing circuit 162 may include components, subsystems, data structures, modules, scripts, applications, or one or more sets of processor-executable instructions for facilitating claim processing. The processing circuit 162 comprises a memory 166, a processor 168, and an adjusting circuit 170. The memory 166 includes one or more memory device (e.g., RAM, NVRAM, ROM, Flash Memory, hard disk storage) that store data and/or computer code for facilitating the various processes described herein. That is, in operation and use, the memory 166 stores at least portions of instructions and data for execution by the processor 168 to control the processing circuit 162. The memory 166 may be or include tangible, non-transient volatile memory and/or non-volatile memory. The processor 168 may be implemented as a general-purpose processor, an application specific integrated circuit (ASIC), one or more field programmable gate arrays (FPGAs), a digital signal processor (DSP), a group of processing components, or other suitable electronic processing components.

The adjusting circuit 170 may include components, subsystems, data structures, modules, scripts, application, or one or more sets of processor—executable instructions for adjusting claims by an adjuster. The adjusting circuit 170 displays the claim to the adjuster. In some embodiments, the adjusting circuit 170 may highlight certain portions of the claim that may require adjuster input. The adjusting circuit 170 receives input from the adjuster to adjust the claim as the adjuster deems necessary.

The input/output circuit 164 is structured to receive communication from and provide communications to the adjuster device 106. The input/output circuit 164 may be structured to communicate, exchange data, instructions, etc. with input/output components (e.g., circuitry) of other systems, devices, etc. In some embodiments, the input/output circuit 164 includes an input/output device, such as a touchscreen. In another embodiment, the input/output circuit 164 includes machine-readable media for facilitating the exchange of information between an input/output device and the components of the adjuster device 106. In some embodiments, the input/output circuit 164 includes any combination of hardware components, communication circuitry, and machine-readable media. Hardware components can include a touchscreen, a keypad, microphone, camera, or buttons for receiving user inputs. Components of the input/output circuit 164 display instructions, status notification and other information (e.g., claim processing progress) to a user. The display (e.g., the touchscreen) may be configured to display graphics such as menus, instructions, background photos (e.g., advertisements, etc.), logos, and so on. In one embodiment, the display is a touchscreen display that is capable of detecting user touches, e.g., to make menu selections. The display allows for the adjuster device 106 to communicate with an adjuster of the financial institution.

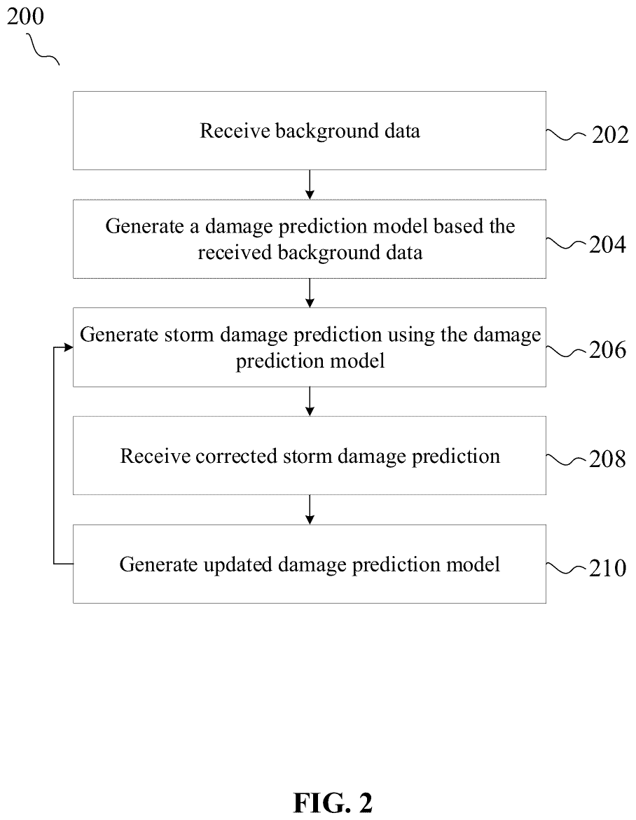

FIG. 2 is a flow diagram of a method 200 of generating and updating a damage prediction model, according to an exemplary embodiment. The method 200 utilizes past storm data, current storm data, and damage data corresponding to the storms to generate the damage prediction model. The damage prediction model may then be supplemented with additional data to continuously improve the results. In some embodiments, the damage prediction model creates a sub-model or branched model specific to a new storm based on data from the particular storm. Sub-models may initially utilize historical models for generating claims, but may transitions to utilizing the new storm data after receiving a predetermined number of claims for the particular storm. The method 200 may be completed by a system or device such as the provider computing system 102, and more specifically the prediction circuit 130. In some embodiments, other circuits or devices configured to complete the processes of method 200 may be included in the provider computing system 102. In some embodiments, the method 200 may be completed in a cloud computing service and accessed by the provider computing system 102.

At process 202, the provider computing system 102 receives background data. The background data may include weather data, such as the historical weather data stored in the weather database 112, vehicle damage data, such as the data stored in the damage database 114, and/or claim data, such as the data stored in the insurance provider database 116. In some embodiments, the provider computing system 102 may further process the background data. For example, the provider computing system 102 may filter the background data by storm type (e.g., wind storm, rainstorm, hail storm, etc.) to generate a plurality of storm damage prediction models for different storm types. In some embodiments, the provider computing system 102 may filter out undesired data (e.g., incorrectly categorized data, incomplete data, unlinked data, etc.) that may negatively impact the accuracy of the damage prediction model.

At process 204, the provider computing system 102 generates a damage prediction model using an artificial intelligence algorithm that utilizes the background data, as described in reference to the prediction circuit 130. The damage prediction model may be applied to storms to determine the damage induced by the storms, in particular the damage to a vehicle expected from a storm. The predicted damage may be used by the claim processing system 100 to expedite and verify an insurance claim process. The damage prediction model may be stored locally in the memory 126 of the provider computing system 102 or may be stored in a cloud server to make it accessible via a network. In some embodiments, the claim processing system 100 may store versions (e.g., editions, iterations, variations, etc.) of the damage prediction model in a memory, such as the memory 126. Storing variations of the damage prediction model provides a backup in case the damage prediction model receives faulty data that significantly negatively impact predictions made by the damage prediction model. In some embodiments, a version history may be stored to allow for troubleshooting and determining what data may be faulty.

At process 206, the provider computing system 102 generates a storm damage prediction using the damage prediction model generated during process 204. The provider computing system 102 utilizes pertinent storm characteristic data corresponding to the storm indicated in the claim as having cause the claimed damage. The pertinent storm characteristic data may be accessed from the weather database 112, which may be populated by a weather monitoring authority, such as a government entity (e.g., National Weather Service, etc.). The pertinent storm characteristic data may include location, size, precipitation amount, precipitation size, precipitation distribution, during, temperature, humidity, air pressure, and the like. The pertinent storm characteristic data is entered into the damage prediction model to generate a storm damage prediction. The prediction may be for a single location, such as the location the claimed damage occurred, or for a larger area, such as the storm impact area, which may be utilized for multiple claims resulting from the same storm. The generated storm damage prediction is used by the claim processing system 100 to expedite claim processing by prefilling expected damage data fields for the customer and to verify that what the customer enters in the claim corresponds to what is as expected.

At process 208, the provider computing system 102 receives corrected storm damage data. The corrected storm damage data is the storm damage data that has been approved by an adjuster and corrected by the customer and the adjuster to reflect the actual damage caused by a storm. In some embodiments, the provider computing system 102 may receive storm damage data that was approved with the originally generated estimates from the storm damage prediction, thus providing the provider computing system 102 with additional data points for training the damage prediction model. At process 210, the provider computing system 102 utilizes the corrected storm damage data and/or any other approved storm damage data to generate an updated damage prediction model. The artificial intelligence algorithms used to generate the damage prediction model use the additional corrected and approved storm damage data to further train the damage prediction model and increase the accuracy of the model. For example, the weather database 112 may be updated to include data for a new storm that is the cause of an insurance claim, such as corresponding to characteristics (e.g., temperature, wind speed, cloud size, hail size, precipitation measurements, duration, location, etc.) of weather events (e.g., storms, etc.). Similarly, the damage database 114 may be updated to include information (e.g., number, depth, width, location, etc.) relating to damage (e.g., dents, scrapes, broken glass, etc.) resulting from the new storm. The weather database information and damage database information may be correlated such that the corrected storm damage data is associated with the weather data for the new storm that caused the damage.

After the updated damage prediction model is generated, the method 200 returns to process 206, during which the updated damaged prediction model is used to generate a storm damage prediction. Processes 206, 208, and 210 repeat every time a new claim is submitted and processed. This allows for the damage prediction model to continuously improve. For example, after a damage-inducing storm, a first customer may submit a first claim. The damage prediction model may generate a first storm damage prediction that is 75% accurate. The corrected storm damage data is then used to further train the damage prediction model. Then a second customer may submit a second claim. This time, since the damage prediction model has been further trained, the damage prediction model may generate a second storm damage prediction is 85% accurate. The corrections for the second claim are then used to, again, train the damage prediction model. This repeats with each additional claim, thus continuously increasing the accuracy of the damage prediction model. In some embodiments, the damage prediction model creates a branch (e.g., sub-model, etc.) for particular storm. The branch utilizes an existing damage prediction model to apply to initial claims, for example applying to claims until a certain threshold is reached, then a branched damage prediction model is generated for the particular storm based on the initial claims and utilizing weather data from the particular storm. The branched model may be utilized for generating storm damage predictions for some or all of the remaining claims relating to the particular storm. In one embodiment, a transition may be utilized where the storm damage prediction is generated using both the damage prediction model and the branched damaged prediction model, such as with a weighting that shifts towards complete use of the branched damage prediction model as a threshold of claims processed is reached. The transition may gradual or may be as a result of a trigger, such as a set number of processed claims. In some embodiments, the set number of processed claims is 50 claims. Further, where a first storm branched model may be used for claims after the threshold for a first storm, later claims associated with a second storm may again utilize the damage prediction model, an updated damage prediction model, such as a main branch model, rather than the first storm branched model used for the first storm or may utilize the first storm branched model. Similarly, a second storm branched model may be developed for the second storm after a certain threshold of claims and based upon the damage prediction model, such as the main branch model. In some embodiments, the main branch model may be updated based upon the data associated with a particular storm.

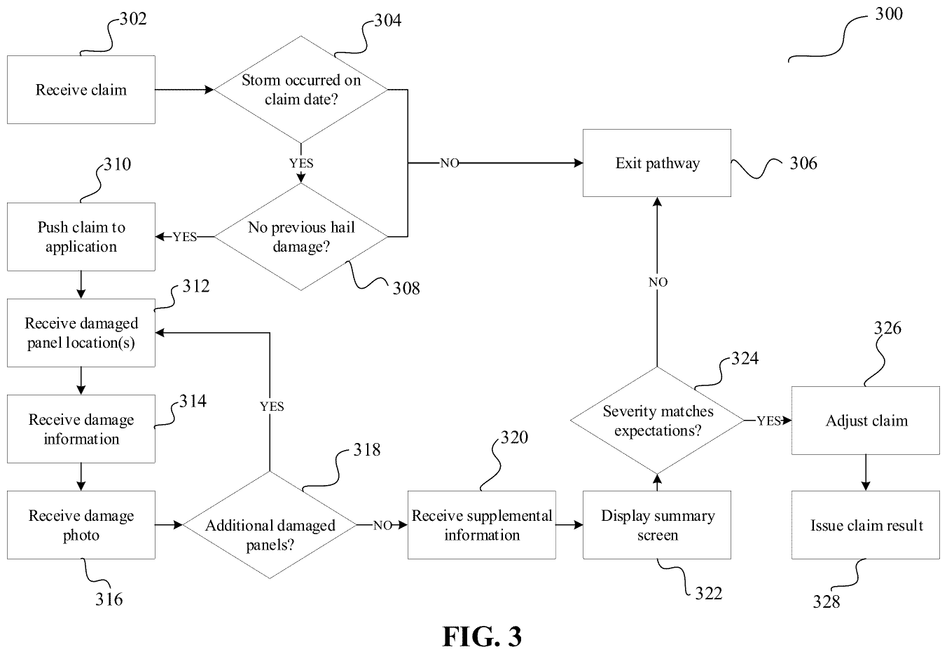

FIG. 3 is a flow diagram of a method 300 of processing a claim and issuing a claim result, according to an exemplary embodiment. The method 300 may be facilitated by a system or device such as the claim processing system 100. The method 300 described herein is for a single claim, but the process may be repeated for multiple claims. In some embodiments, the claim processing system 100 may include hardware and software to allow the claim processing system 100 to process multiple claims in parallel (e.g., simultaneously).

At process 302, the claim processing system 100 receives a claim from a customer. The claim may be entered via the customer device 104 and may include customer identification information, such as an account number, customer name, etc., and claim information, such as vehicle damaged, damage date, damage location, etc. In some embodiments, the claim processing system 100 authenticates the customer by verifying the customer identification information with the data stored in the insurance provider database 116. In some embodiments, the customer may specifically indicate that the damage came from a particular weather event, such as hail. At process 304, the claim processing system 100 verifies, by the rules engine 132, whether a storm occurred on the date indicated in the claim. If a storm did not occur on the date indicated in the claim, the method 300 continues to process 306. At process 306, the redirection circuit 136 direct the customer to exit the current claim processing pathway. In some embodiments, the rules engine 132 may determine is specifically a damage-inducing storm occurred on the date indicated in the claim.

If the rules engine 132 determines that a storm occurred on the date indicated in the claim, the method 300 continues to process 308. At process 308, the rules engine 132 determines whether the vehicle indicated in the claim has any previous damage that was claimed but was never repaired, or was never indicated as repaired. If the rules engine 132 determines that there was unrepaired damage, the method 300 continues to process 306. If the rules engine 132 determines that there was no unrepaired damage claimed for the vehicle of the claim, the method 300 continues to process 310.

At process 310, the claim processing system 100 pushes the customer the claim processing application. The claim processing application may be stored on the customer device 104 and facilitates claim processing by displaying information to the customer and receiving input from the customer. The application may automatically prepopulate and/or automatically configure based customer information. For example, the application may configure itself for vehicle types (e.g., truck, SUV, hatch-back, etc.) and may display different images and/or features corresponding to the customer information. Furthermore, the application may reconfigure the display language based on customer preference.

At process 312, the claim processing system 100 receives an indication of which panels (e.g., hood, left door, right door, roof, etc.) are damaged in the vehicle. The indication may be a customer selecting a depiction of vehicle panels on the customer device 104 or selecting vehicle panels from a list presented to the customer. The list and/or the depiction may correspond to the vehicle type the customer indicated in the claim. At process 314, the claim processing system 100 receives damage information corresponding to the indicated damaged panels. The damage information may be pre-populated by the claim processing system 100 generating a storm damage prediction using the damage prediction model. The customer may approve or correct the pre-populated damage information to match the actual damage. At process 316, the claim processing system 100 receives a photo of the damage from the customer. The application on the customer device 104 instructs the customer to take photos of the particular damaged panels. The claim processing system 100 may link the damage photo to the damage information and store it in the memory, such as memory 126, or the at least one of the databases 110. At process 318, the customer may input that additional panels are damaged that were not previously indicated. If so, the method 300 returns to and continues from process 312. If no additional panels are indicated as damaged, the method 300 continues to process 320.

At process 320, the claim processing system 100 receives supplemental damage information, which may correspond to damage of non-panel portions of a vehicle (e.g., trim, glass, lights, etc.). The supplemental damage information may be pre-populated by the claim processing system 100 using the generated storm damage prediction. The customer may approve or correct the pre-populated damage information to match the actual damage.

At process 322, the claim processing system 100 displays a summary screen to the customer. The summary screen includes a summary of the information entered or approved by the customer. The customer may approve the summary or may enter additional information as needed. After the summary is approved, an estimate of costs of damage (e.g., dollar amount) may be added to the claim by the claim processing system 100 based on past data. For example, a certain number of dents may have a first repair cost associated, while a second number of dents may have a second repair cost associated.

At process 324, the decision engine 134 determines if the severity of damage indicated in the images of the damage corresponds to the damage indicated in the claim. The decision engine 134 may also determine if the damage in the images corresponds to the storm damage prediction or if it significantly varies. For example, the damage in the images may be compared to the prediction based upon the damage prediction model. If the decision engine 134 determines that the severity of damage does not corresponds to the indicated and/or expected damage, the method 300 proceeds to process 306. If the decision engine 134 determines that the severity of damage corresponds to the indicated and/or expected damage, the method 300 proceeds to process 326. In some embodiments, process 324 is optional, and the method 300 may proceed directly from process 322 to process 326. In one embodiment, the damage prediction model is updated based upon the damage in the images, the insurance claim and the weather data for the associated storm. For example, the decision engine 134 determines if the variance between the damage in the images and the storm damage prediction is above a threshold and the damaged prediction model is updated.

At process 326, an adjuster receives the claim and reviews and adjusts the claim as necessary. Once the adjuster finalizes the claim, a claim result is issued at 328. The claim result may be an approval or a rejection, based on the adjuster's decision. An approval may include a summary of damage and repairs needs as well as prompt for a customer to receive a recommended repair facility. The recommendation circuit 154 may then generate a recommendation list for the customer.

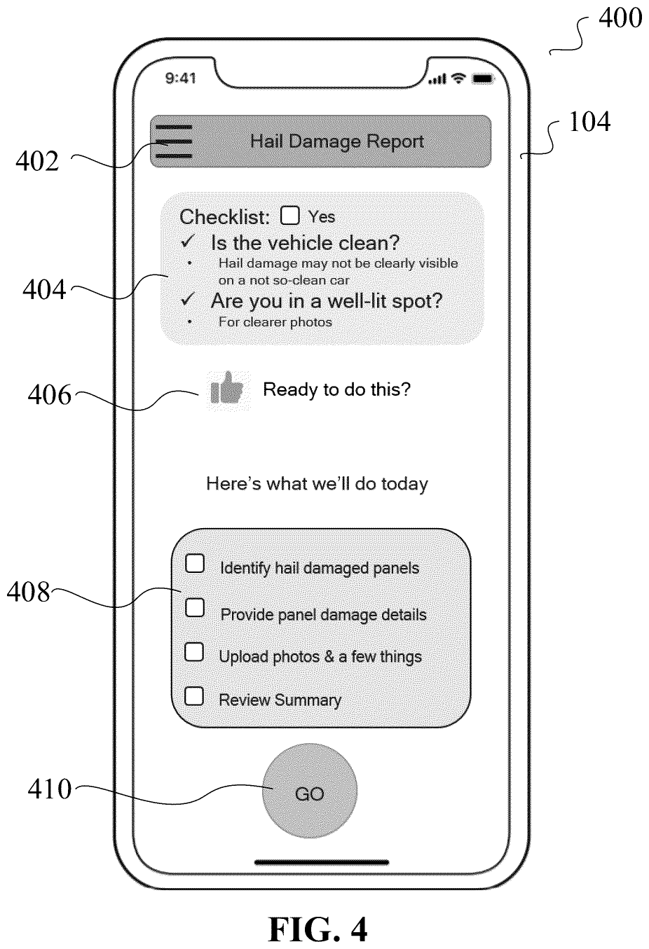

Referring generally to FIGS. 4-11, a customer device 104 is depicted displaying exemplary screens. The depicted screens correspond to those displayed to a customer while processing a claim, as described in reference to FIG. 3. The customer device 104 depicted in the aforementioned figures is a mobile device, but in other embodiments, the customer device 104 may be any other device capable of displaying information and receive input to process insurance claims. Furthermore, the screens depicted in the aforementioned figures are configured for a mobile device, but may be reconfigured for other customer devices 104. The screens may also be changed or altered depending on the needs of the insurance provider and the customer. Furthermore, the embodiments of the aforementioned figures relate to hail damage, but the methods and systems described herein may be applied for other types of damage resulting from weather events. In some embodiments, after each screen is completed, the claim processing system 100 may save the claim progress to a memory, such as the memory 126, or may upload the claim progress to a cloud server. In the aforementioned figures, the customer may correct prepopulated data to match actual data, these corrections, once approved by an adjuster, and may be further used to train the damage prediction model.

FIG. 4 is an illustration of a customer device 104 displaying a user interface 400 prompting a customer to prepare for submitting a claim, according to an exemplary embodiment. The user interface 400 includes a summary panel 402 which indicates which service the customer is using (e.g., hail damage reporting, wind damage reporting, etc.). The summary panel 402 may include a drop-down menu that allows for the user to switch between services. The user interface 400 further includes a checklist 404. The checklist 404 includes a confirmation box that the customer may press to indicate that the directions within the checklist 404 are completed. The direction within the checklist 404 may direct the customer to prepare the vehicle for claim processing, such as cleaning the vehicle to clearly show damage and ensuring that there is proper light for capturing images of the damage. The user interface 400 includes confirmation 406 which may indicate whether the customer may proceed to the next step, such as when the checklist 404 is completed. The user interface 400 further includes a process summary 408 which informs the customer of the general process of the claim process. The user interface 400 further includes a confirmation button 410 that, when pressed by the customer, instructs the customer device 104 to proceed to the next screen.

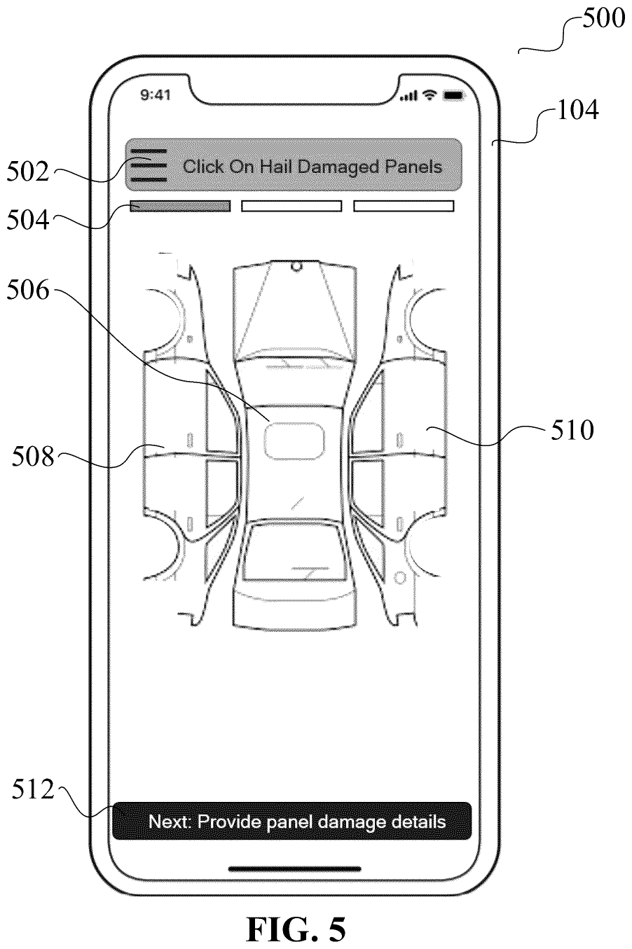

FIG. 5 is an illustration of a customer device 104 displaying a user interface 500 prompting a customer to select panels of a vehicle, according to an exemplary embodiment. In some embodiments, the user interface 500 may be displayed directly after the user interface 400. The user interface 500 corresponds to the process 312 of method 300. The user interface 500 includes a summary panel 502 that displays informative text instructing the customer of what to do on the screen (e.g., click on hail damaged panels, etc.). The summary panel 502 may include a dropdown menu that may allow the customer to navigate to other steps of the claim process. The user interface 500 further includes a progress meter 504. The progress meter 504 indicates how much of the process has been completed. The user interface 500 further includes a vehicle top view 506, a vehicle left side view 508, and a vehicle right side view 510. The three views may correspond to the type of vehicle that was claimed to be damaged. For example, if the claim if for a damaged sedan, the three views would depict a top, left side, and right side view of a sedan. The panels on the three views are selectable so that the customer may indicate which panels were damaged. In some embodiments, the panels that are selected by the customer may be highlighted to indicate selection. The customer may also unselect panels to correct mistakes. In some embodiments, panels may be preselected by the claim processing system 100 based on the storm damage prediction. Once the customer has chosen damaged panels, the customer may press a continuation button 512, which instructs the customer to proceed to the next screen.

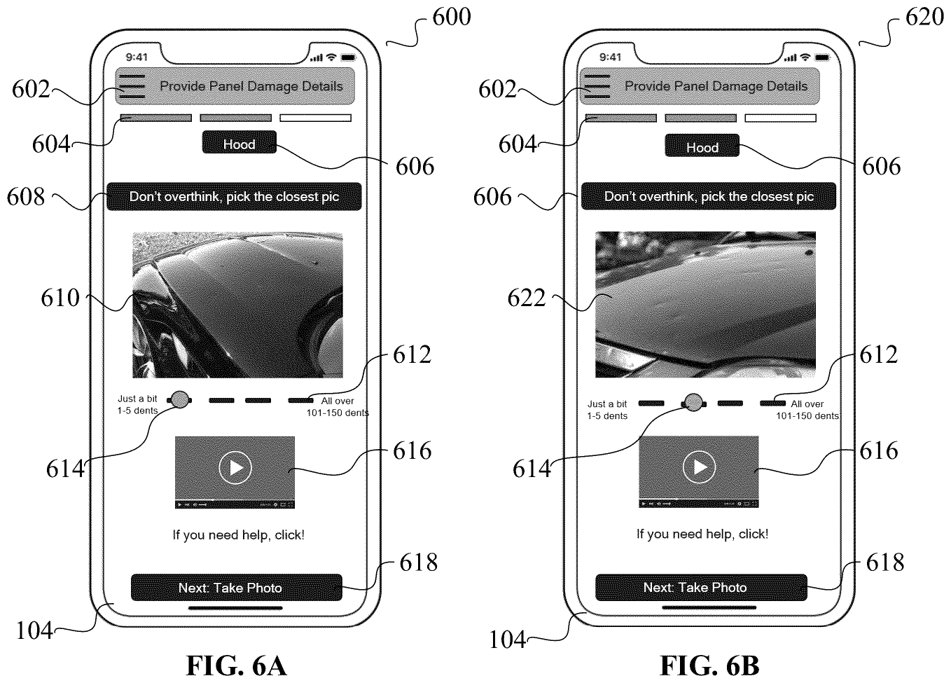

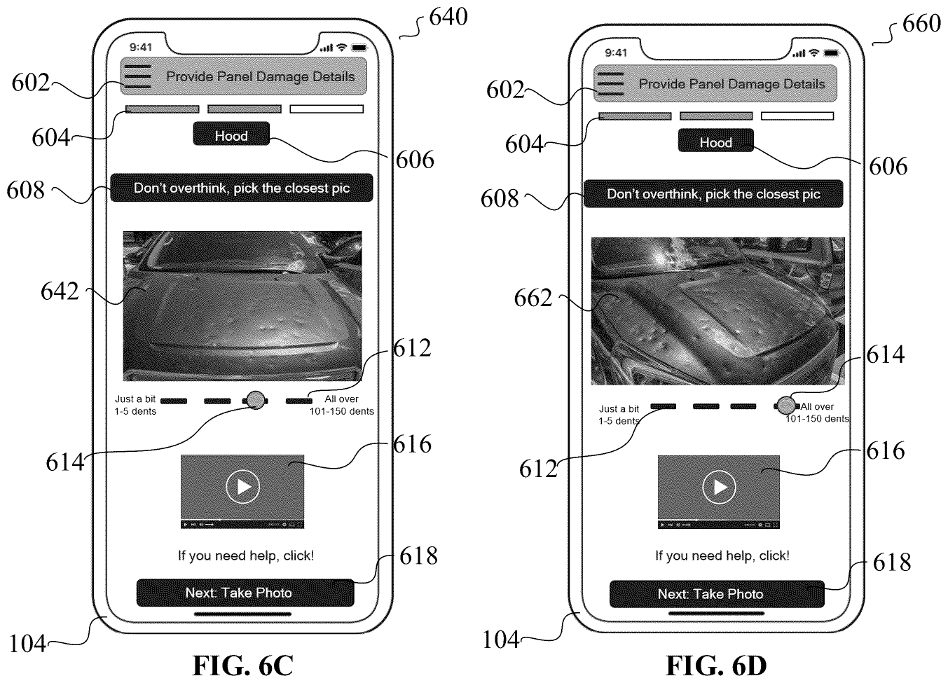

Referring generally to FIGS. 6A-D, illustrations of a customer device 104 displaying user interfaces prompting a customer to select damage intensity are shown, according to exemplary embodiments. The aforementioned screen depict damage of varying intensity. The aforementioned figures correspond to process 314 of method 300 for a single panel, but additional user interfaces may be included for other vehicle panels. The aforementioned figures may be displayed directly after the user interface 500.

The aforementioned figures all include user interfaces including a summary panel 602 that displays informative text instructing the customer of what to do on the screen (e.g., provide panel damage details, etc.). The summary panel 602 may include a dropdown menu that may allow the customer to navigate to other steps of the claim process. The user interfaces include a progress meter 604. The progress meter 604 indicates how much of the claim process has been completed. The user interfaces further include a panel indicator 606, which indicates which panel the customer is entering information for. The user interfaces further include additional directions 608, which provide the customer with additional directions or motivations on what to do on the screen. The user interfaces further includes a scale 612 and a slider 614. The scale 612 indicates a scale of damage. For example, in the case of hail damage, the slider may scale from 1-5 dents to 101-150 dents. The slider 614 is repositionable along the scale 612 to indicate the amount of damage on the panel. The position of the slider 614 may be pre-set by the provider computing system 102 based on the storm damage estimate. The user interfaces additionally include an instructional video 616, which a customer may press to watch an instructional video that may explain the present process. The user interfaces further include a confirmation button 618 which, when pressed by the customer, indicates that customer has confirmed the position of the slider 614.

FIG. 6A depicts a user interface 600, which further includes a damage photo 610 and the slider 614 positioned to the lowest setting on the scale 612 corresponding to only minor hail damage. FIG. 6B depicts a user interface 620, which further includes a damage photo 622 and the slider 614 positioned to the second setting on the scale 612 corresponding to hail damage that is greater than that indicated in FIG. 6A. FIG. 6C depicts a user interface 640, which further includes a damage photo 642 and the slider 614 positioned to a third setting on the scale 612 corresponding to hail damage that is great than that depiction in FIG. 6B. FIG. 6D depicts a user interface 660, which further includes a damage photo 662 and the slider 614 positioned to the highest setting on the scale 612 corresponding to only minor hail damage. Each of the damage photos correspond to the damage indicated by the slider 614. As the customer adjusts the slider 614 along the scale 612, a different user interface with the corresponding damage photo is shown.

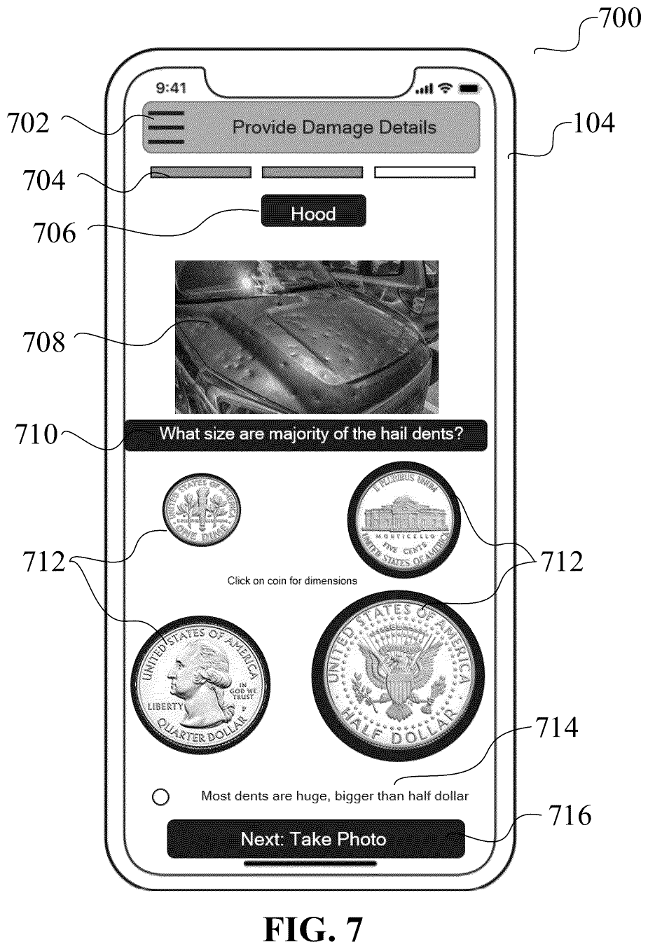

FIG. 7 is an illustration of a customer device 104 displaying a user interface 700 prompting a customer to select damage size, according to an exemplary embodiment. The user interface 700 corresponds to the process 314 of method 300. The user interface 700 includes a summary panel 702 that displays informative text instructing the customer of what to do on the screen (e.g., provide panel damage details, etc.). The summary panel 702 may include a dropdown menu that may allow the customer to navigate to other steps of the claim process. The user interface 700 includes a progress meter 704. The progress meter 704 indicates how much of the claim process has been completed. The user interface 700 further includes a panel indicator 706, which indicates which panel the customer is entering information for. The user interface 700 further includes a damage image 708, the damage image 708 corresponds to the damage image of FIGS. 6A-6D that is chosen by the customer. The user interface 700 further includes additional directions 710 which provide the customer with additional directions or motivations on what to do on the screen. The user interface 700 further includes size buttons 712, each of which corresponding to a different size coin. The type of coin may be configured to the country in which the claim processing system 100 is used. The size buttons 712 correspond to the size of hail damage and allow for a customer to click on the size button 712 that corresponds to the majority of the hail dents. If the hail damage is larger than the largest depicted coin, the customer may press another button 714 that indicates that the claimed damage is larger than the largest depicted size button 712. The size buttons 712 or the other button 714 may be pre-set by the provider computing system 102 based on the storm damage estimate. The user interface 700 includes a confirmation button 716 which, when pressed by the customer, indicates that customer has confirmed the size of the majority of the damage.

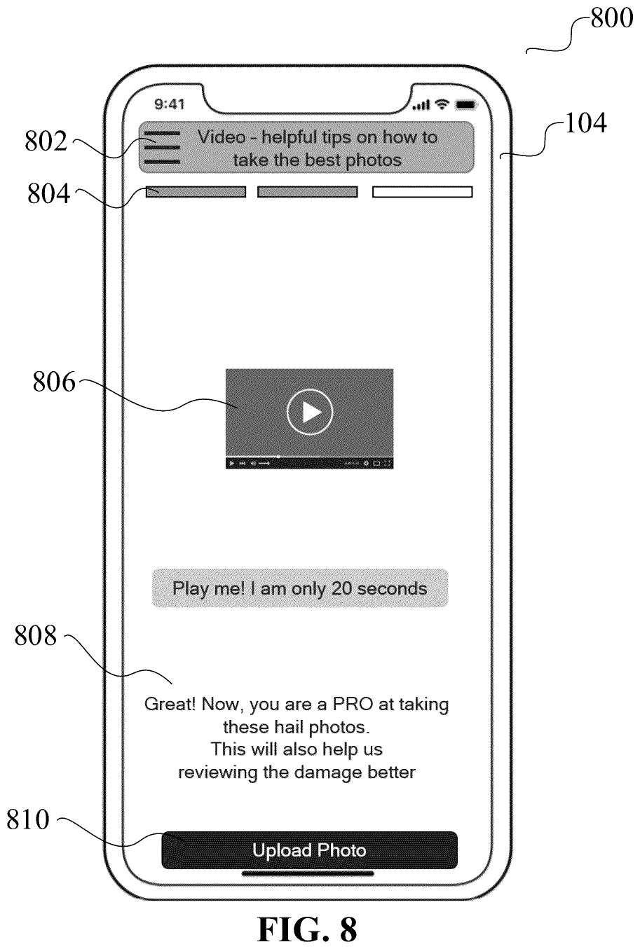

FIG. 8 is an illustration of a customer device 104 displaying a user interface 800 prompting a customer watch an informational video and upload damage photos, according to an exemplary embodiment. The user interface 800 may be shown directly after the user interface 700. The user interface 800 corresponds to process 316 of the method 300. The user interface 800 includes a summary panel 802 that displays informative text instructing the customer of what to do on the screen (e.g., helpful tips, etc.). The summary panel 802 may include a dropdown menu that may allow the customer to navigate to other steps of the claim process. The user interface 800 includes a progress meter 804. The progress meter 804 indicates how much of the claim process has been completed. The user interface 800 further includes an instructional video 806, that when pressed by the customer, explains to the customer how to take a photo of the damage. The user interface 800 includes additional motivational wording 808 that directs the customer to upload photos of the damage. The user interface further includes an uploading button 810 that, when pressed, prompts the customer to upload a photo of the damaged panels of the vehicle.

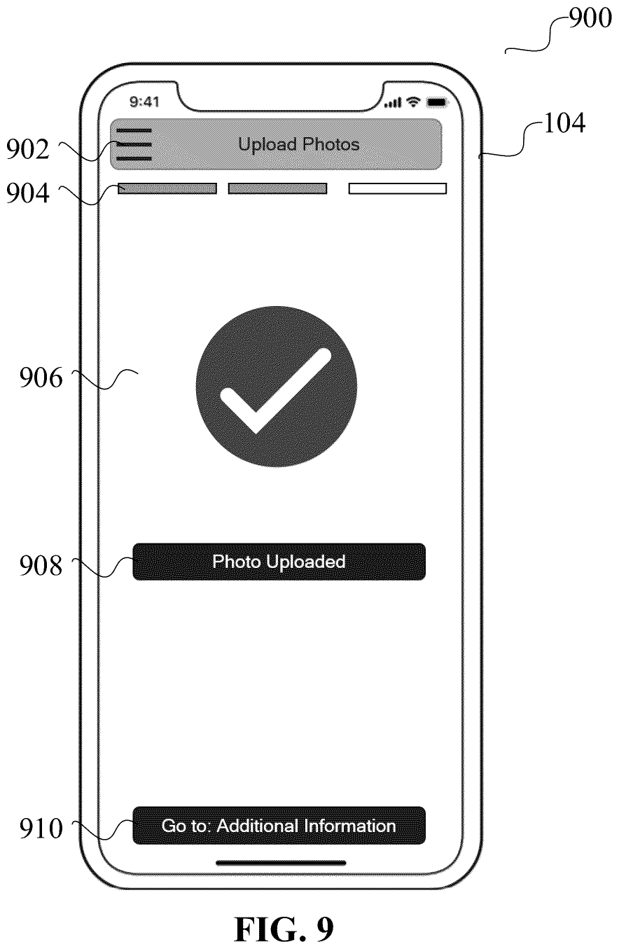

FIG. 9 is an illustration of a customer device 104 displaying a user interface 900 displaying an upload confirmation, according to an exemplary embodiment. The user interface 900 may be shown directly after the user interface 800. The user interface 900 corresponds to the process 316 of the method 300. The user interface 900 includes a summary panel 902 that displays informative text instructing the customer of what to do on the screen (e.g., upload photos, etc.). The summary panel 902 may include a dropdown menu that may allow the customer to navigate to other steps of the claim process. The user interface 900 includes a progress meter 904. The progress meter 904 indicates how much of the claim process has been completed. The user interface 900 includes an upload confirmation 906 which indicates whether the images have been successfully uploaded and/or stored by the claims processing system 100. The upload confirmation 906 may also indicate whether the photos are satisfactory (e.g., have desirable framing, desirable lighting, etc.). The user interface 900 further includes an upload button 908 which may provide the status of the photos (e.g., uploaded, loading, not accepted, etc.). In some embodiments, clicking on the upload button 908 may allow the customer to view the uploaded photo and/or upload a new photo. The user interface 900 further includes a confirmation button 910 which, when pressed by the customer, indicates that customer has confirmed the photo.

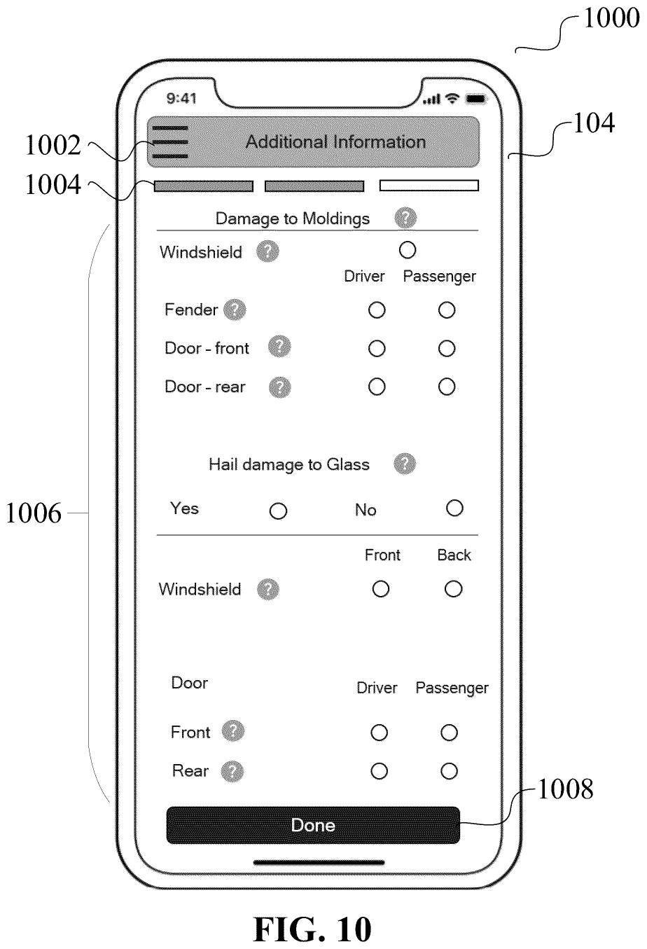

FIG. 10 is an illustration of a customer device 104 displaying a user interface 1000 prompting a customer to confirm and/or modify pre-populated additional information, according to an exemplary embodiment. The user interface corresponds to the process 320 of the method 300. The user interface 1000 includes a summary panel 1002 that displays informative text instructing the customer of what to do on the screen (e.g., additional information, etc.). The summary panel 1002 may include a dropdown menu that may allow the customer to navigate to other steps of the claim process. The user interface 1000 includes a progress meter 1004. The progress meter 1004 indicates how much of the claim process has been completed. The user interface 1000 includes a listing of additional information 1006 corresponding to additional vehicle damage beyond panel damage. The additional information 1006 is pre-populated by the claim processing system 100 based on the storm damage prediction. The customer may adjust each additional information 1006 if the actual damage does not correspond to the pre-populated entries. Once the customer has confirmed and approved each additional information 1006, the customer may press the confirmation button 1008 to proceed to the next screen.

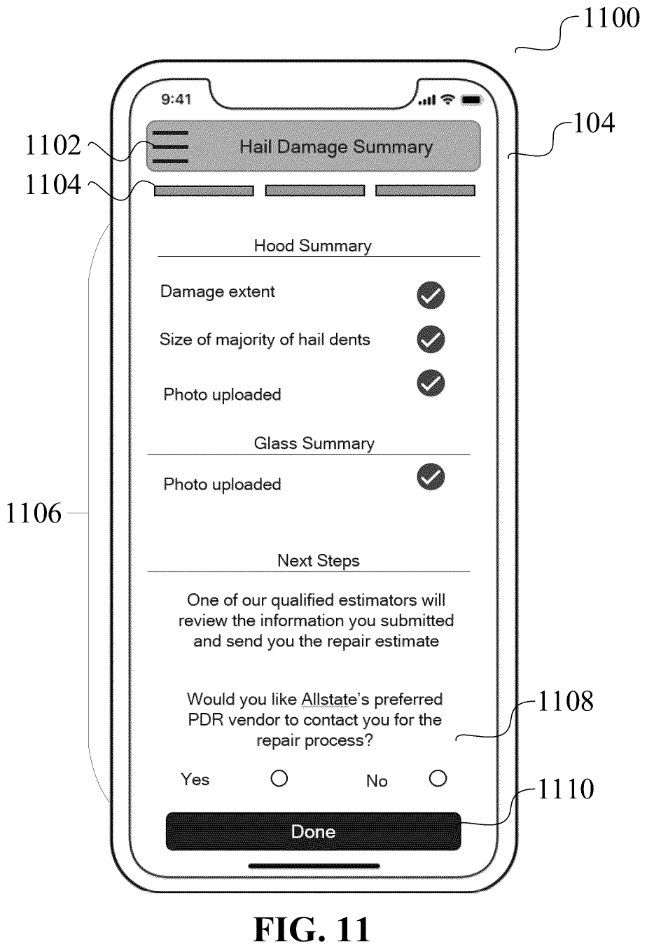

FIG. 11 is an illustration of a customer device 104 displaying a user interface 1100 displaying a summary of an insurance claim, according to an exemplary embodiment. The user interface 1100 may be shown directly after the user interface 1000. The user interface 1100 corresponds to the process 322 of the method 300. The user interface 1100 includes a summary panel 1102 that displays informative text instructing the customer of what to do on the screen (e.g., hail damage summary, etc.). The summary panel 1102 may include a dropdown menu that may allow the customer to navigate to other steps of the claim process. The user interface 1100 includes a progress meter 1104. The progress meter 1004 indicates that the claim process is nearly completed. The user interface 1100 includes a summary listing 1106. The summary listing 1106 indicates that all the steps on the application have been completed. The user interface 1100 includes a preferred vendor offer 1108, which allows for a customer to indicate whether the customer is interested in being offered a preferred repair facility. Once the customer has reviewed the summary listing 1106 and the preferred vendor offer 1108, the customer may submit the claim by pressing the confirmation button 1110. The provider computing system 102 may then redirect the claim to the adjuster device 106 for final adjustment and approval.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method for processing insurance claims, the method comprising:
receiving, by a provider computing system, background data;
generating, by the provider computing system, a damage prediction model based on the background data;
receiving, from a first customer device, a first insurance claim for a vehicle, the first insurance claim corresponding to a first storm;
generating, by the provider computing system, a first storm damage prediction of damage to the vehicle due to the first storm;
receiving, from the customer device, a first storm damage information based on actual damage to the vehicle from the first storm;
evaluating, by the provider computing system, the first storm damage information in light of to the first storm damage prediction;
receiving, by the provider computing system, first storm weather data; and
generating, by the provider computing system, a first updated damage prediction model based on the background data, the first storm weather data, and the first storm damage information.

2. The method of claim 1 further comprising:
receiving, from a second customer device, a second insurance claim for a second vehicle, the second insurance claim corresponding to the first storm;
applying, by the provider computing system, the first updated damage prediction model to the second insurance claim;
receiving, from the customer device, a second storm damage information based on actual damage to the second vehicle from the first storm; and
revising, by the provider computing system, the first updated damage prediction model based on the background data, the first storm weather data, the second storm damage information.

3. The method of claim 1, wherein the first storm is a hail storm.

4. The method of claim 1, wherein the damage prediction model is generated by an artificial intelligence algorithm.

5. The method of claim 1, wherein the first storm damage information comprises:
damage information; and
damage images.

6. The method of claim 5 further comprising:
validating, by the provider computing system, the first storm damage information by verifying whether the damage images correspond to the damage information.

7. The method of claim 6, wherein verifying whether the damage images correspond to the damage information comprises:
extracting, by the provider computing system using an artificial intelligence algorithm, characteristics from the damage images; and
comparing, by the provider computing system, the characteristics from the damage images to the damage information.

8. An insurance claim processing system, the insurance claim processing system comprising:
a first customer device; and
a provider computing system communicatively coupled to the first customer device, the provider computing system comprising a processor and a memory, the memory storing instructions that cause the processor to:
receive background data;
generate a damage prediction model based on the background data;
receive, from the first customer device, a first insurance claim for a vehicle, the first insurance corresponding to a first storm;
generate a first storm damage prediction of damage to the vehicle due to the first storm;
apply the first storm damage prediction to the first insurance claim;
receive, from the customer device, a first storm damage information based actual damage to the vehicle from the first storm; and
generate a first updated damage prediction model based on the background data, the first storm weather data, and the first storm damage information.

9. The insurance claim processing system of claim 8, wherein the provider computing system is further configured to:
receive, from a second customer device, a second insurance claim for a second vehicle, the second insurance claim corresponding to the first storm;
apply the first updated damage prediction model to the second insurance claim;
receive, from the customer device, a second storm damage information based on actual damage to the second vehicle from the first storm; and
revising the first updated damage prediction model based on the background data, the first storm weather data, the second storm damage information.

10. The insurance claim processing system of claim 8, wherein the first storm is a hail storm.

11. The insurance claim processing system of claim 8, wherein the damage prediction model is generated by an artificial intelligence algorithm.

12. The insurance claim processing system of claim 8, wherein the first storm damage information comprises:
damage information; and
damage images.

13. The insurance claim processing system of claim 12, wherein the provider computing system is further configured to:
validate the first storm damage information by verifying whether the damage images correspond to the damage information.

14. The insurance claim processing system of claim 13, wherein verifying whether the damage images correspond to the damage information comprises:
extract, using an artificial intelligence algorithm, characteristics from the damage images; and
comparing the characteristics from the damage images to the damage information.

15. A non-transitory computer readable medium having computer-executable instructions embodied therein that, when executed by a processor of a computing system, cause the computing system to perform operations to process insurance claims, the operations comprising:
receive background data;
generate a damage prediction model based on the background data;
receive, from the first customer device, a first insurance claim for a vehicle, the first insurance corresponding to a first storm;
generate a first storm damage prediction of damage to the vehicle due to the first storm;
apply the first storm damage prediction to the first insurance claim;
receive, from the customer device, a first storm damage information based actual damage to the vehicle from the first storm; and
generate a first updated damage prediction model based on the background data, the first storm weather data, and the first storm damage information.

16. The computer readable medium of claim 15, wherein the operations further comprise:
receive, from a second customer device, a second insurance claim for a second vehicle, the second insurance claim corresponding to the first storm;
apply the first updated damage prediction model to the second insurance claim;
receive, from the customer device, a second storm damage information based on actual damage to the second vehicle from the first storm; and
revising the first updated damage prediction model based on the background data, the first storm weather data, the second storm damage information.

17. The computer readable medium of claim 15, wherein the damage prediction model is generated by an artificial intelligence algorithm.

18. The computer readable medium of claim 15, wherein the first storm damage information comprises:
damage information; and
damage images.

19. The computer readable medium of claim 18, wherein the operations further comprise:
validating the first storm damage information by verifying whether the damage images correspond to the damage information.

20. The computer readable medium of claim 19, wherein verifying whether the damage images correspond to the damage information comprises:
extracting, using an artificial intelligence algorithm, characteristics from the damage images; and
comparing the characteristics from the damage images to the damage information.
